(19) United States
(12) Patent Application Publication
(10) Pub. No.: US 2025/0181134 A1
(43) Pub. Date: Jun. 5, 2025

(54) MANAGING POWER STATE TRANSITIONS USING MACHINE LEARNING IN A MEMORY SUB-SYSTEM

(71) Applicant: Micron Technology, Inc., Boise, ID (US)

(72) Inventors: Seyhan Karakulak, San Jose, CA (US); David Scott Ebsen, Minnetonka, MN (US); Saeed Sharifi Tehrani, San Diego, CA (US); Jay Sarkar, San Jose, CA (US)

(21) Appl. No.: 18/959,056

(22) Filed: Nov. 25, 2024

Related U.S. Application Data
(60) Provisional application No. 63/606,475, filed on Dec. 5, 2023.

(51) Int. Cl. G06F 1/3225; G06F 1/324; G06F 11/34

(52) U.S. Cl. CPC G06F 1/3225; G06F 1/324; G06F 11/3433

(57) ABSTRACT

Systems and methods are disclosed including a memory device and a processing device operatively coupled to the memory device. The processing device can perform operations including providing current workload data of the memory device as input to a machine learning model, wherein the machine learning model is trained, using a plurality of workload data, to identify one or more power-saving parameters associated with each workload data of the plurality of workload data. The processing device can perform operations further including obtaining an output of the machine learning model, the output comprising the one or more power-saving parameters associated with the current workload data. The processing device can perform operations further including adjusting, based on the one or more power-saving parameters associated with the current workload data, a power state of the memory device.

### RELATED APPLICATIONS

This application claims the benefit of U.S. Provisional Patent Application Ser. No. 63/606,475 filed Dec. 5, 2023, the entire contents of which are hereby incorporated by reference herein.

### TECHNICAL FIELD

Embodiments of the disclosure relate generally to memory sub-systems, and more specifically, relate to managing power state transitions using machine learning in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system, in accordance with some embodiments of the present disclosure.

FIG. 2 illustrates an example system architecture that includes a memory sub-system, in accordance with some embodiments of the present disclosure

FIG. 3 illustrates an example data structure storing one or more power-savings parameters, in accordance with aspects of the present disclosure.

FIG. 4 is a flow diagram of an example method of managing power state transitions using machine learning in a memory sub-system, in accordance with some embodiments of the present disclosure.

FIG. 5 is a flow diagram of an example method of training a machine learning model, in accordance with some embodiments of the present disclosure.

FIG. 6 is a block diagram of an example computer system in which embodiments of the present disclosure can operate.

### DETAILED DESCRIPTION

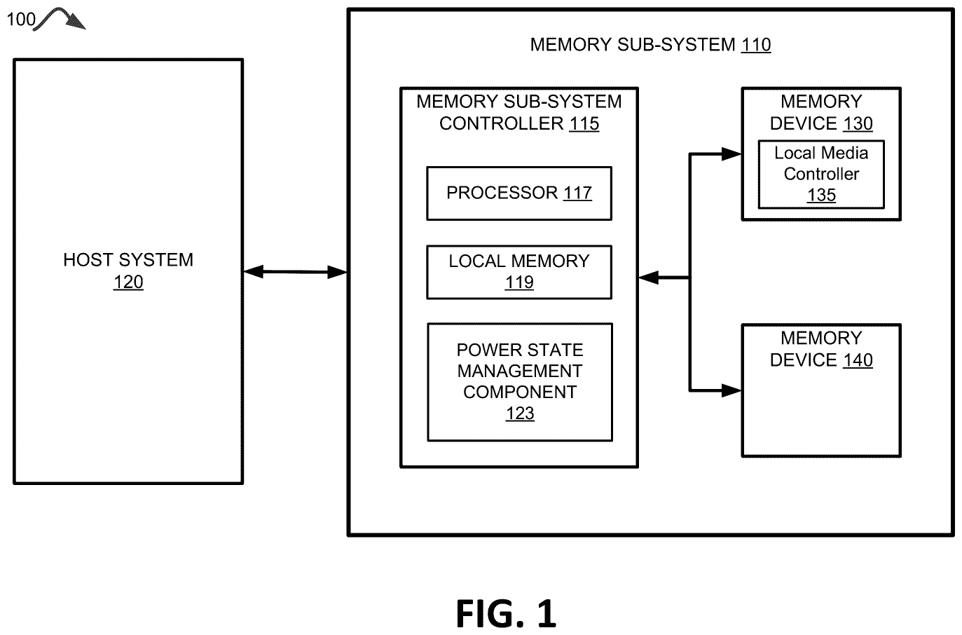

Aspects of the present disclosure are directed to managing power state transitions using machine learning in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. One example of a non-volatile memory device is a not-and (NAND) memory device. Other examples of non-volatile memory devices are described below in conjunction with FIG. 1. A non-volatile memory device is a package of one or more dice. Each die can include one or more planes. For some types of non-volatile memory devices (e.g., NAND devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), etc.

The memory sub-system can be in one of multiple power states, including one or more higher power states and one or more lower power states (e.g., an active state, an idle state, a low power (hibernate) state, a deep sleep state, etc.). In certain instances, the memory sub-system can transition among the one or more higher and lower power states in response to particular conditions being detected, such as the passage of a threshold amount of time without receiving a memory access command, battery charge falling below a threshold level, receiving a request for a power state change, etc. In an active state, the memory sub-system is awake and in a full running state in which the memory sub-system accepts host commands and performs read and/or write operations requested by the host. An idle state can be a state in which host commands are not being received, though the memory sub-system is still awake (e.g., devices and/or components are still powered on). In a low power (e.g., hibernate) state, power consumption is reduced to a low level, and processing is stopped for periods of time. System clocks can be slowed down to reduce power consumption by the memory sub-system. Certain components, such as memory cells, can remain powered on. A sleep state can be a state in which the memory sub-system is shut down, e.g., not performing operations.

The capability of memory sub-systems to transition from, e.g., a higher power state to a lower power state can assist with reducing the power consumption of the memory sub-system. In turn, the reduction in power consumption can lead to an overall improvement in the performance of the memory sub-system, as well as a reduction in the total cost of ownership (TCO) of the memory sub-system. Typical memory sub-systems, however, fail to take into account the current workload (also referred to herein as “workload data”) of a memory device when transitioning from one power state to another power state. The workload refers to the amount and type of data operations that a memory device can handle within a specific period. For example, the workload can include the quantity of data read from or written to the memory device (e.g., data volume), the speed at which data is read from or written to the memory device (e.g., data transfer rate), the frequency and manner in which data is accessed (e.g., random and/or sequential data access), the number of simultaneous read and/or write operations the memory device can handle at a given time, the type of operations being performed (e.g., read operation, write operation), etc. A memory device with a higher (e.g., more demanding) workload often requires more power consumption in order to provide the higher bandwidth necessary to meet the higher workload, while a memory device with a lower (e.g., less demanding) workload often requires relatively less power consumption, as a lower bandwidth can be sufficient to meet the lower workload. In some memory sub-systems, a bursty workload of write operation traffic (e.g., a pattern of performing write operations characterized by sudden, intermittent spikes or bursts of activity followed by periods of relative inactivity or lower activity levels) can demand more power consumption than a workload comprising read operation traffic. As discussed above, however, memory sub-systems do not typically transition to a certain power state in response to the workload needs of a memory device. Instead, memory sub-systems typically transition among the one or more higher and lower power states in response to particular conditions being detected, such as the passage of a threshold amount of time without receiving a memory access command, battery charge falling below a threshold level, receiving a request for a power state change, etc. This can result in needless power consumption, for example, when the memory sub-system is in the high power state even though the current workload has a relatively low power consumption. As such, there is a need for optimized power consumption that takes into account the current workload of a memory device when transitioning from one power state to another power state using machine learning. While the current workload of a memory device may be characterized using non-machine learning approaches (e.g., rule-based algorithms), such non-machine learning approaches can be ineffective in optimizing the transition between power states to save power consumption.

Aspects of the present disclosure address the above and other deficiencies by managing power state transitions using machine learning in a memory sub-system. In some implementations, a memory sub-system controller provides current workload data of a memory device of the memory sub-system as input to a trained machine learning model. The trained machine learning model can be trained using a set of workload data to identify one or more power-saving parameters that can be implemented when a memory device is experiencing a particular workload data of the set of workload data. For example, the one or more power-saving parameters can include a power (e.g., power consumption) per memory access operation, an application-specific integrated circuit (ASIC) clock domain frequency, a central processing unit (CPU) frequency, etc. The memory sub-system controller can obtain an output from the machine learning model that includes the one or more power-saving parameters that satisfy the current workload data of the memory device. In some implementations, the memory sub-system controller adjusts the power state of the memory device based on the one or more power-savings parameters. For example, adjusting the power state of the memory device can include transitioning the memory device to a lower power state or to a higher power state (e.g., an active state, an idle state, a low power (hibernate) state, a deep sleep state, etc.).

Advantages of the present disclosure include, but are not limited to, a reduction in power consumption of the memory sub-system by optimizing power state transitions using machine learning, which can lead to an increase in overall power savings, an overall improvement in the performance of the memory sub-system, as well as a reduction in the total cost of ownership (TCO) of the memory sub-system. In addition, aspects of the present disclosure can help to mitigate climate change by reducing the power consumption of memory devices, which are increasingly popular in data centers, a major source of greenhouse gas emissions. Further, there can also be a reduction in the need for cooling energy in data centers, which can lead to additional savings by lowering operating costs, as cooling is one of the largest sources of power consumption in data centers. Although embodiments are described using memory cells of a NAND flash memory, aspects of the present disclosure can be applied to other types of memory sub-systems.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g. 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local controller 132) on the die and a controller (e.g., memory sub-system controller 115) for media management within the same memory device package. An example of a managed memory device is a managed NAND (MNAND) device.

In some embodiments, the memory sub-system 110 and/or the host system 120 includes at least a portion of power state management component 123. For example, the memory sub-system controller 115 can include a processor 117 (processing device) configured to execute instructions stored in local memory 119 for performing the operations described herein. In some embodiments, the power state management component 123 is part of an application, or an operating system.

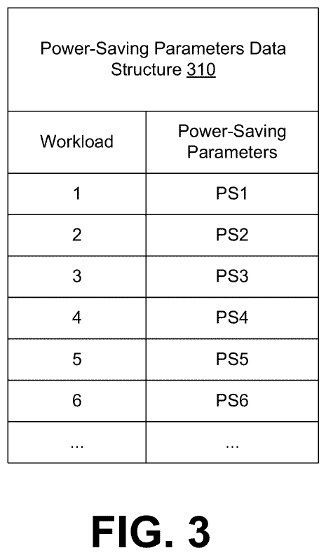

In some embodiments, the power state management component 123 provides current workload data of a memory device of the memory sub-system as input to a trained machine learning model. The trained machine learning model can be trained using a set of workload data to identify one or more power-saving parameters that can be used to satisfy a particular workload data of the set of workload data. For example, the one or more power-saving parameters can include a power (e.g., power consumption) per memory access operation, an application-specific integrated circuit (ASIC) clock domain frequency, a central processing unit (CPU) frequency, etc. The power state management component 123 can obtain an output from the machine learning model that includes the one or more power-saving parameters that satisfy the current workload data of the memory device. In some implementations, the power state management component 123 adjusts the power state of the memory device based on the one or more power-savings parameters. For example, adjusting the power state of the memory device can include transitioning the memory device to a lower power state or to a higher power state (e.g., an active state, an idle state, a low power (hibernate) state, a deep sleep state, etc.). Further detail regarding the power state management component 123 is described with respect to FIGS. 3-5.

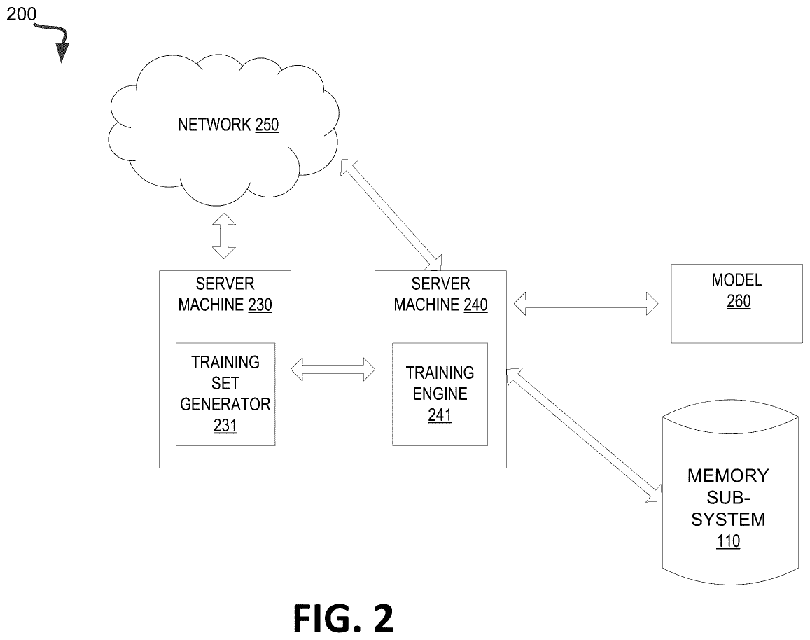

FIG. 2 illustrates an example system architecture 200 that includes a memory sub-system 110, in accordance with some embodiments of the present disclosure. System architecture 200 includes memory sub-system 110, a server machine 230, a server machine 240, and a network 250. Network 250 may be a public network (e.g., the Internet), a private network (e.g., a local area network (LAN) or wide area network (WAN)), or a combination thereof.

The server machine 230 can include a training set generator 231 that is capable of generating training data (e.g., a set of training inputs and a set of target outputs) to train a machine learning model (e.g., model 260) to identify one or more power-saving parameters for each workload data of an input set of workload data. The server machine 240 can include a training engine 241 to train a machine learning model using the training data from training set generator 231 and save the trained model as model 260. The machine learning model 260 may refer to a model artifact that is created by the training engine 241 using the training data that includes training inputs and corresponding target outputs (correct answers for respective training inputs). The training engine 241 can find patterns in the training data that map the training input to the target output (the answer to be predicted), and provide the machine learning model 260 that captures these patterns. The machine learning model 260 may be composed of, e.g., a single level of linear or non-linear operations (e.g., a support vector machine [SVM]) or may be a deep network, i.e., a machine learning model that is composed of multiple levels of non-linear operations). An example of a deep network is a neural network with one or more hidden layer, and such machine learning model may be trained, for example, by adjusting weights of a neural network in accordance with a backpropagation learning algorithm or the like. In some embodiments, the machine learning model 260 can be a regression model. A regression model provides a function that describes the relationship between one or more independent (feature) variables and a response, dependent, or target variable. The regression model may include a linear regression model, a multiple regression model, a non-linear regression model, and stepwise regression model. In some embodiments, the machine learning model 260 can be an autoregressive integrated moving average model, a supervised learning model, an unsupervised learning model, a semi-supervised learning model, a Bayesian model, and/or a reinforcement learning model.

Although some specifications are illustrated above, it should be understood that the number and type of machine learning models that are used and the arrangement of such machine learning models can be modified to achieve the same or similar end results according to the aspects of the present disclosure. In some embodiments, one or more machine learning models are trained to perform one or more of the power state optimization tasks, such as, for example, optimization for different workloads. Each task may be performed by a separate machine learning model. Alternatively, a single machine learning model may perform each of the tasks or a subset of the tasks. Additionally, or alternatively, different machine learning models may be trained to perform different combinations of the tasks. In one example, the trained machine learning model is a single shared neural network that has multiple shared layers and multiple higher level distinct output layers.

It should be noted that, in some implementations, the functions of server machines 230 and 240 may be provided by a fewer or greater number of machines. For example, in some implementations, server machines 230 and 240 may be integrated into a single machine.

FIG. 3 illustrates an example data structure storing one or more power-savings parameters, in accordance with aspects of the present disclosure. As described, a trained machine learning model (e.g., model 260 of FIG. 2) can be trained to identify (e.g., output) one or more power-saving parameters that satisfy a particular workload data of a set of workload data of a memory device. In some embodiments, the one or more power-saving parameters can include power (e.g., power consumption) per memory access operation, an application-specific integrated circuit (ASIC) clock domain frequency, a central processing unit (CPU) frequency, etc. In some embodiments, the workload data can refer to the amount and type of data operations that a memory device can handle within a specific period. For example, the workload data can include the quantity of data read from or written to the memory device (e.g., data volume), the speed at which data is read from or written to the memory device (e.g., data transfer rate), the frequency and manner in which data is accessed (e.g., random and/or sequential data access), the number of simultaneous read and/or write operations the memory device can handle at a given time, the type of operations being performed (e.g., read operation, write operation), etc. As illustrated in FIG. 3, the one or more power-savings parameters identified for a particular workload data can be stored in one or more data structures 310. In some embodiments, an entry of the data structure 310 can store particular workload data (e.g., workload 1) and a corresponding one or more power-saving parameters (e.g., PS1). For example, for a particular workload data (e.g., workload 1) corresponding to a low workload (e.g., a low amount of read operation traffic to a memory device), which thus requires a lower bandwidth of the memory device, the one or more power-saving parameters (e.g., PS1) corresponding to the particular workload data can include a lower power per memory access operation and/or a lower ASIC clock domain frequency and/or a lower CPU frequency. In another example, for another workload data (e.g., workload 2) corresponding to a high workload (e.g., a high amount of write operation traffic to a memory device), which thus requires a higher bandwidth of the memory device, the one or more power-savings parameters (e.g., PS2) corresponding to the particular workload data can include a higher power per memory access operation and/or a higher ASIC clock domain frequency and/or a higher CPU frequency. In some embodiments, other types of power-saving parameters can be identified.

In some embodiments, the data structure 310 can be hosted by one or more storage devices, such as main memory, magnetic or optical storage based disks, tapes or hard drives, NAS, SAN, and so forth. In some implementations, the data structure 310 can be saved in a network-attached file server, while in other embodiments, the data structure 310 can be saved in other type of persistent storage such as an object-oriented database, a relational database, and so forth, that may be hosted by a server machine or one or more different machines coupled to the via a network.

In some embodiments, power state management component 123 of FIG. 1 can maintain the data structure 310. In some embodiments, the data structure 310 can be stored in memory of the memory sub-system (e.g., at memory device 130, 140, local memory 119, etc.) and can be referenced by power state management component 123.

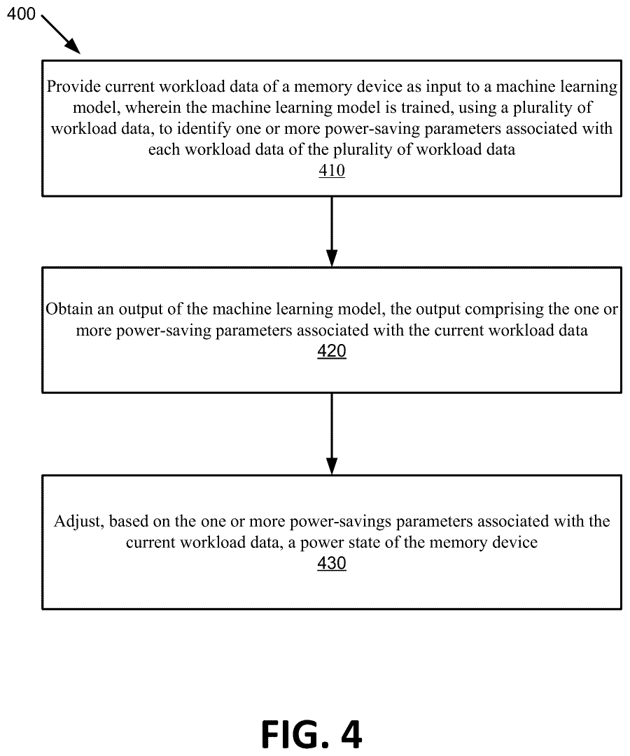

FIG. 4 is a flow diagram of an example method 400 of managing power state transitions using machine learning in a memory sub-system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the power state management component 123 of FIG. 1. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 410, the processing logic provides current workload data of a memory device (e.g., memory device 130 of FIG. 1) of a memory sub-system (e.g., memory sub-system 110 of FIG. 1) as input to a trained machine learning model (e.g., model 260 of FIG. 2). In some embodiments, the processing logic obtains the current workload data by measuring the current workload of the memory device. For example, the current workload data can include one or more of: the quantity of data read from or written to the memory device (e.g., data volume), the speed at which data is read from or written to the memory device (e.g., data transfer rate), the frequency and manner in which data is accessed (e.g., random and/or sequential data access), the number of simultaneous read and/or write operations the memory device can handle at a given time, the type of operations being performed (e.g., read operation, write operation), etc.

In some embodiments, the processing logic providing the current workload data as input to the machine learning model is triggered in response to the processing logic detecting a change to the current workload (e.g., a change in the quantity of data read from or written to the memory device, a change in the speed at which data is read from or written to the memory device, a change in the frequency and/or manner in which data is being accessed at the memory device, a change in the number of simultaneous read and/or write operations that the memory device can handle at a given time, a change in the type of operations being performed at the memory device, etc.). In some embodiments, the processing logic providing the current workload data as input to the machine learning model is triggered in response to determining that a particular predefined period of time has elapsed. In some embodiments, the period of time can be predefined during a manufacturing phase of the memory device and stored on the memory device.

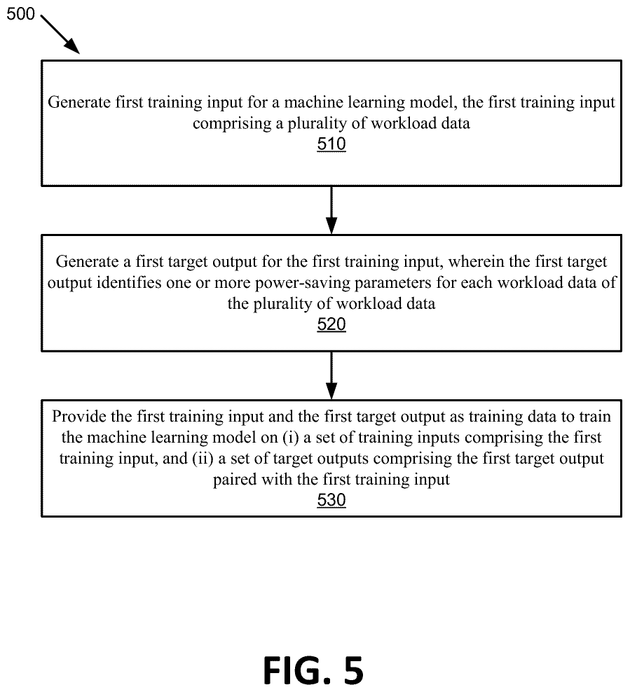

In some embodiments, the trained machine learning model can be trained by generating training data for the machine learning model. Generating training data can include generating training input including a set of workload data and generating a target output for the training input, where the target output identifies one or more power-saving parameters for each workload data of the set of workload data. The training data can be provided to train the machine learning model on (i) a set of training inputs including the training input, and (ii) a set of target outputs including the target output paired with the training input. In some embodiments, the machine learning model includes at least one of: a regression model, an autoregressive integrated moving average model, a supervised learning model, an unsupervised learning model, a semi-supervised learning model, a Bayesian model, or a reinforcement learning model. Further detail regarding training the machine learning model is described with respect to FIG. 2 and FIG. 5.

At operation 420, the processing logic obtains an output from the machine learning model. In some embodiments, the output can include one or more power-saving parameters that satisfy the current workload data of the memory device. For example, the one or more power-saving parameters can include a power (e.g., power consumption) per memory access operation, an application-specific integrated circuit (ASIC) clock domain frequency, a central processing unit (CPU) frequency, etc. For example, if the current workload data of the memory device indicates a lower current workload that thus requires a lower bandwidth, then the one or more power-saving parameters can include a lower power per memory access operation and/or a lower ASIC clock domain frequency and/or a lower CPU frequency. In another example, if the current workload data of the memory device indicates a higher current workload that thus requires a higher bandwidth, then the one or more power-savings parameters can include a higher power per memory access operation and/or a higher ASIC clock domain frequency and/or a higher CPU frequency. In some embodiments, other types of power-saving parameters can be identified.

At operation 430, the processing logic adjusts the power state of the memory device based on the one or more power-savings parameters identified at operation 420. For example, in some embodiments, the processing logic can adjust the power state of the memory device by transitioning the memory device to a lower power state. In some embodiments, the processing logic can adjust the power state of the memory device by transitioning the memory device to a higher power state. As described above, the one or more power states can include, e.g., an active state, an idle state, a low power (hibernate) state, a deep sleep state, etc. In some embodiments, transitioning the memory device to a lower power state can correspond with a lower current workload which requires a lower bandwidth, as described above. In some embodiments, transitioning the memory device to a higher power state can correspond with a higher current workload which requires a higher bandwidth, as described above.

In some embodiments, in response to adjusting the power state of the memory device, the processing logic can determine a power savings value associated with adjusting the power state of the memory device (e.g., an amount of power consumption (e.g., energy) saved by adjusting the power state of the memory device). For example, the power savings value can be determined (e.g., computed) by summing the power consumed for each operation executed while the memory device in the adjusted power state. The processing logic can sum the power consumed for each operation executed if the memory device operated at a highest power state. The processing logic can compute the difference between the sum of the power consumed for each operation executed while the memory device in the adjusted power state and the sum of the power consumed for each operation executed if the memory device operated at a highest power state. The computed difference can be referred to as the power savings value associated with adjusting the power state of the memory device. In some embodiments, the processing logic can store the power savings value in a data structure associated with the memory device, such as in an entry of the data structure 310 of FIG. 3.

FIG. 5 is a flow diagram of an example method 500 of training a machine learning model for managing power state transitions in a memory sub-system, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the power state management component 123 of FIG. 1, the training set generator 231 of FIG. 2, and/or the training engine 241 of FIG. 2. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 510, the processing logic generates training input (e.g., first training input) for the machine learning model. In some embodiments, the machine learning model can be at least one of: a regression model, an autoregressive integrated moving average model, a supervised learning model, an unsupervised learning model, a semi-supervised learning model, a Bayesian model, or a reinforcement learning model. The training input can include a set of workload data. In some embodiments, the set of workload data can be obtained at certain pre-defined intervals from a memory device (e.g., an SSD), a segment of the memory device (e.g., a die), or multiple memory devices (e.g., an SSD population). In some embodiments, the set of workload data can be synthetic data generated to capture various types of workloads that a memory device can experience. In some embodiments, the set of workload data can be provided by a device (e.g., a user device, a client device, etc.). As described above, workload data can refer to one or more of: the quantity of data read from or written to the memory device (e.g., data volume), the speed at which data is read from or written to the memory device (e.g., data transfer rate), the frequency and manner in which data is accessed (e.g., random and/or sequential data access), the number of simultaneous read and/or write operations the memory device can handle at a given time, the type of operations being performed (e.g., read operation, write operation), etc. In some embodiments, other types of workload data can be included.

At operation 520, the processing logic generates a target output (e.g., a first target output) for the training input. In some embodiments, the target output identifies one or more power-saving parameters for each workload data of the set of workload data. For example, the one or more power-savings parameters can include power (e.g., power consumption) per memory access operation, an application-specific integrated circuit (ASIC) clock domain frequency, a central processing unit (CPU) frequency, etc.

At operation 530, the processing logic provides the training data to train the machine learning model on (i) a set of training inputs including the training input generated at block 510, and (ii) a set of target outputs including the target output generated at block 520. In the case of a neural network, for example, input values of a given input/output mapping (e.g., numerical values associated with training inputs generated at block 510) are input to the neural network, and output values (e.g., numerical values associated with target outputs generated at block 520) of the input/output mapping are stored in the output nodes of the neural network. The connection weights in the neural network are then adjusted in accordance with a learning algorithm (e.g., backpropagation, etc.), and the procedure is repeated for the other input/output mappings in the training data. In some embodiments, the machine learning model can be trained using training engine 241 of server machine 240. The trained machine learning model can be implemented by training engine 241 (of server machine 250) to identify one or more power-savings parameters for a current workload of a memory device, as described herein.

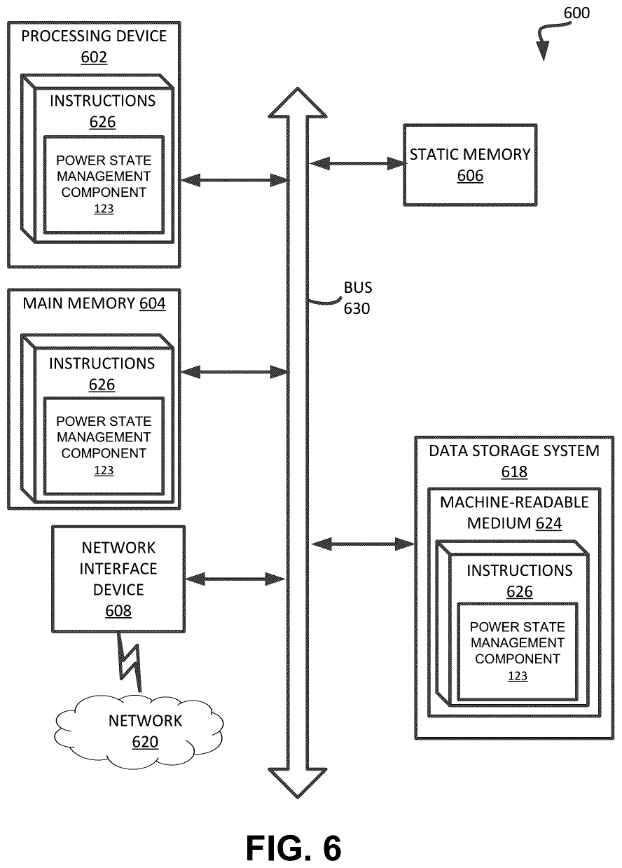

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes or utilizes a memory sub-system (e.g., the memory sub-system 110 of FIG. 1) or can be used to perform the operations of a controller (e.g., to execute an operating system to perform operations corresponding to power state management component 123 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630. Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to power state management component 123 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
providing current workload data of the memory device as input to a machine learning model, wherein the machine learning model is trained, using a plurality of workload data, to identify one or more power-saving parameters associated with each workload data of the plurality of workload data;
obtaining an output of the machine learning model, the output comprising the one or more power-saving parameters associated with the current workload data; and
adjusting, based on the one or more power-saving parameters associated with the current workload data, a power state of the memory device.

2. The system of claim 1, wherein the current workload data indicates a lower current workload, and wherein to adjust the power state of the memory device, the processing device is to perform operations further comprising:
transitioning to a lower power state.

3. The system of claim 1, wherein the current workload data indicates a higher current workload, and wherein to adjust the power state of the memory device, the processing device is to perform operations further comprising:
transitioning to a higher power state.

4. The system of claim 1, wherein the current workload data corresponds to a current bandwidth of the memory device.

5. The system of claim 1, wherein the one or more power-saving parameters associated with the current workload data comprises one or more of: power per memory access operation, an application-specific integrated circuit (ASIC) clock domain frequency, or a central processing unit (CPU) frequency.

6. The system of claim 1, wherein the processing device is to perform operations further comprising:
generating training data for the machine learning model, wherein generating the training data comprises:
generating first training input, the first training input comprising the plurality of workload data; and
generating a first target output for the first training input, wherein the first target output identifies the one or more power-saving parameters for each workload data of the plurality of workload data; and
providing the training data to train the machine learning model on (i) a set of training inputs comprising the first training input, and (ii) a set of target outputs comprising the first target output paired with the first training input.

7. The system of claim 1, wherein the machine learning model comprises at least one of: a regression model, an autoregressive integrated moving average model, a supervised learning model, an unsupervised learning model, a semi-supervised learning model, a Bayesian model, or a reinforcement learning model.

8. The system of claim 1, wherein the processing device is to perform operations further comprising:
in response to adjusting the power state of the memory device, determining a power savings value associated with adjusting the power state of the memory device.

9. The system of claim 1, wherein providing the current workload data of the memory device as input to the machine learning model is triggered in response to a change to the current workload.

10. A method, comprising:
providing, by a processing device, current workload data of a memory device as input to a machine learning model, wherein the machine learning model is trained, using a plurality of workload data, to identify one or more power-saving parameters associated with each workload data of the plurality of workload data;
obtaining an output of the machine learning model, the output comprising the one or more power-saving parameters associated with the current workload data; and
adjusting, based on the one or more power-saving parameters associated with the current workload data, a power state of the memory device.

11. The method of claim 10, wherein the current workload data indicates a lower current workload, and wherein adjusting the power state of the memory device further comprises:
transitioning to a lower power state.

12. The method of claim 10, wherein the current workload data indicates a higher current workload, and wherein adjusting the power state of the memory device further comprises:
transitioning to a higher power state.

13. The method of claim 10, wherein the one or more power-saving parameters associated with the current workload data comprises one or more of: power per memory access operation, an application-specific integrated circuit (ASIC) clock domain frequency, or a central processing unit (CPU) frequency.

14. The method of claim 10, further comprising:
generating training data for the machine learning model, wherein generating the training data comprises:
generating first training input, the first training input comprising the plurality of workload data; and
generating a first target output for the first training input, wherein the first target output identifies the one or more power-saving parameters for each workload data of the plurality of workload data; and
providing the training data to train the machine learning model on (i) a set of training inputs comprising the first training input, and (ii) a set of target outputs comprising the first target output paired with the first training input.

15. The method of claim 10, wherein the machine learning model comprises at least one of: a regression model, an autoregressive integrated moving average model, a supervised learning model, an unsupervised learning model, a semi-supervised learning model, a Bayesian model, or a reinforcement learning model.

16. A non-transitory computer-readable storage medium comprising instructions that, when executed by a processing device operatively coupled to a memory, performs operations comprising:
providing current workload data of a memory device as input to a machine learning model, wherein the machine learning model is trained, using a plurality of workload data, to identify one or more power-saving parameters associated with each workload data of the plurality of workload data;
obtaining an output of the machine learning model, the output comprising the one or more power-saving parameters associated with the current workload data; and
adjusting, based on the one or more power-saving parameters associated with the current workload data, a power state of the memory device.

17. The non-transitory computer-readable storage medium of claim 16, wherein the current workload data indicates a lower current workload, and wherein to adjust the power state of the memory device, the processing device is to perform operations further comprising:
transitioning to a lower power state.

18. The non-transitory computer-readable storage medium of claim 16, wherein the current workload data indicates a higher current workload, and wherein to adjust the power state of the memory device, the processing device is to perform operations further comprising:
transitioning to a higher power state.

19. The non-transitory computer-readable storage medium of claim 16, wherein the processing device is to perform operations further comprising:
generating training data for the machine learning model, wherein generating the training data comprises:
generating first training input, the first training input comprising the plurality of workload data; and
generating a first target output for the first training input, wherein the first target output identifies the one or more power-saving parameters for each workload data of the plurality of workload data; and
providing the training data to train the machine learning model on (i) a set of training inputs comprising the first training input, and (ii) a set of target outputs comprising the first target output paired with the first training input.

20. The non-transitory computer-readable storage medium of claim 16, wherein the processing device is to perform operations further comprising:
in response to adjusting the power state of the memory device, determining a power savings value associated with adjusting the power state of the memory device.
